(19) United States
(12) Patent Application Publication
(10) Pub. No.: US 2024/0085207 A1
(43) Pub. Date: Mar. 14, 2024

(54) INFORMATION PROCESSING SYSTEM

(71) Applicant: HONDA MOTOR CO., LTD., Tokyo (JP)

(72) Inventors: Junichiro Onaka, Tokyo (JP); Kenta Maruyama, Tokyo (JP); Junya Obara, Tokyo (JP); Yusuke Ishida, Tokyo (JP)

(21) Appl. No.: 18/242,044

(22) Filed: Sep. 5, 2023

(30) Foreign Application Priority Data
Sep. 8, 2022 (JP) 2022-142727

(51) Int. Cl. G01C 21/36; G06V 20/59; G06V 40/10

(52) U.S. Cl. CPC G01C 21/3629; G01C 21/3602; G01C 21/3608; G01C 21/3647; G06V 20/59; G06V 40/10

(57) ABSTRACT

An information processing system includes a first device that is mounted on a mobile object boarded by an occupant, and a second device that is used by a user at a location different from the mobile object, in which the first device includes a first speaker configured to output a voice uttered by the user, and a camera unit that is provided on a predetermined seat of the mobile object and has one or more cameras including at least an indoor camera capable of capturing an image of an interior of the mobile object viewed from the predetermined seat, the second device includes a detection device for detecting an orientation direction, which is a face orientation or gaze direction, of the user, and a display device configured to display an image corresponding to the orientation direction viewed from the predetermined seat among images captured by the camera unit.

### CROSS-REFERENCE TO RELATED APPLICATION

Priority is claimed on Japanese Patent Application No. 2022-142727, filed Sep. 8, 2022, the content of which is incorporated herein by reference.

### BACKGROUND

### Field of the Invention

The present invention relates to an information processing system.

### Description of Related Art

Conventionally, research has been conducted on sharing images of scenery outside a vehicle and the like by performing communication between a device mounted on a mobile object such as a vehicle and a device used in a different location from the mobile object (Japanese Unexamined Patent Application, First Publication No. 2020-94958).

### SUMMARY

With conventional technologies, neither an occupant of a mobile object nor a user in a different location from the mobile object may feel a sufficient sense of presence in some cases.

The present invention has been made in consideration of such circumstances, and one of the objects is to provide an information processing system capable of enhancing a sense of presence given to both an occupant of a mobile object and a user who is in a different location from the mobile object.

The information processing system according to the present invention has adopted the following configuration.

(1): An information processing system according to one aspect of the present invention includes a first device that is mounted on a mobile object boarded by an occupant, and a second device that is used by a user at a location different from the mobile object, in which the first device includes a first communication device configured to communicate with a second communication device of the second device, a first speaker configured to output a voice uttered by the user, which is acquired via the first communication device, and a camera unit that is provided on a predetermined seat of the mobile object and has one or more cameras including at least an indoor camera capable of capturing an image of an interior of the mobile object viewed from the predetermined seat, the second device includes the second communication device configured to communicate with the first communication device, a second microphone configured to collect a voice uttered by the user, a detection device for detecting an orientation direction of the user, and a display device configured to display an image corresponding to the orientation direction viewed from the predetermined seat among images captured by the camera unit, and the second communication device transmits a voice collected by the second microphone to the first communication device.

(2): In the aspect of (1) described above, the first speaker may cause the occupant to localize a sound image so that the voice is audible from the predetermined seat and outputs the voice uttered by the user.

(3): In the aspect of (2) described above, the first speaker may include a plurality of first child speakers arranged at positions different from each other, and the first device may further include a first control device that causes the occupant to localize a sound image so that the voice is audible from the predetermined seat by adjusting a volume and/or a phase difference of the plurality of first child speakers.

(4): In the aspect of (3) described above, the second device may further acquire height information indicating a height of the head of the user, and the first control device may cause the occupant to localize a sound image so that the voice is audible from a height position according to the height of the head of the user on the predetermined seat, and cause the first speaker to output the voice uttered by the user.

(5): In the aspect of (1) described above, the second device may further acquire height information indicating a height of the head of the user, and the display device may display an image corresponding to the orientation direction viewed from the height indicated by the height information on the predetermined seat.

(6): In the aspect of (1) described above, the second communication device may transmit information on the orientation direction to the first communication device, the first device may further have a first control device for controlling the first communication device to selectively transmit the image corresponding to the orientation direction acquired via the first communication device among the images captured by the camera unit to the second communication device, and a display device of the second device may display the image corresponding to the orientation direction viewed from the predetermined seat, which is acquired via the second communication device.

(7): In the aspect of (1) described above, the first communication device may transmit the images captured by the camera unit to the second communication device, and the second device may further have a second control device that causes the display device to selectively display the image corresponding to the orientation direction among the images captured by the camera unit.

(8): In the aspect of (1) described above, the first device may further have at least a first microphone that collects a voice uttered by the occupant, and the second device further has a second speaker that outputs the voice uttered by the occupant and acquired via the second communication device, and the first communication device may transmit a voice collected by the first microphone to the second communication device.

(9): In the aspect of (8) described above, the second speaker may cause the user to localize a sound image so that a voice is audible from a position of the occupant viewed from the predetermined seat, and output the voice uttered by the occupant.

(10): In the aspect of (1) described above, the display device may be a display device of virtual reality (VR) goggles, and the detection device may include a physical sensor attached to the VR goggles.

(11): In the aspect of (1) described above, the display device may be capable of executing a mode in which a displayable angular range of the display device is limited.

(12): In the aspect of (1) described above, the mobile object may be a vehicle, and the predetermined seat may be an assistant driver's seat.

(13): In the aspect of (1) described above, the display device may replace a portion of the images captured by the camera in which a predetermined article inside the mobile object is captured with an image drawn by computer processing, and display the image.

According to the aspects of (1) to (13), it is possible to enhance a sense of presence given to both an occupant of a mobile object and a user who is in a different location from the mobile object.

### BRIEF DESCRIPTION OF THE DRAWINGS

FIG. 1 is a diagram which shows a usage environment and the like of an information processing system and a management server.

FIG. 2 is a diagram which shows an example of content of user data.

FIG. 3 is a configuration diagram of a first device.

FIG. 4 is a diagram which shows an arrangement example of part of the first device in a mobile object.

FIG. 5 is a configuration diagram of a second device.

FIG. 6 is a diagram for describing an image corresponding to an orientation direction.

FIG. 7 is a diagram which shows a first example of a functional configuration of a first control device and a second control device.

FIG. 8 is a diagram which shows a second example of the functional configuration of the first control device and the second control device.

FIG. 9 is a diagram which shows an example of a display of a replacement image.

### DESCRIPTION OF EMBODIMENTS

An embodiment of an information processing system of the present invention will be described below with reference to the drawings. The information processing system includes a first device mounted on a mobile object boarded by an occupant and a second device used by a user at a location different from the mobile object. The mobile object is, for example, a vehicle, but can be any mobile objects as long as it can be boarded by an occupant. In addition, the occupant is mainly a driver of the mobile object, but it can be an occupant other than the driver.

Between the first device and the second device, the voice collected by the microphone is transmitted to the other party and played back by a speaker to create a state like a telephone call, and furthermore, mixed reality (MR) is provided to the second device side by displaying a part of an image captured by a camera unit of the first device using the second device. The first device and the second device do not need to be in a one-to-one relationship, and one of a plurality of first devices and a plurality of second devices may be matched in a one-to-many relationship to operate as an information processing system. In the latter case, for example, one occupant can communicate with a plurality of users simultaneously or in sequence.

<Reference Configuration>

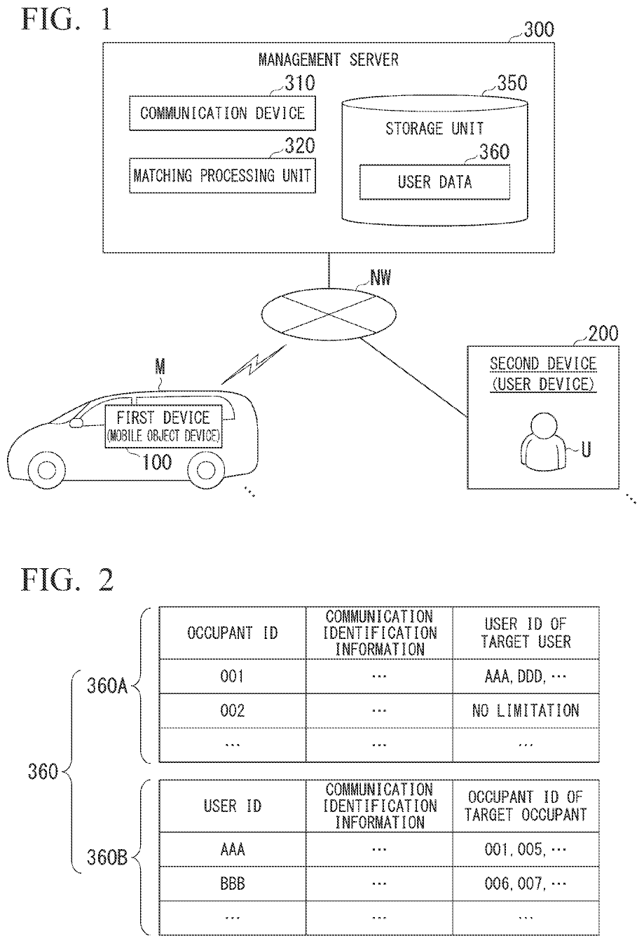

FIG. 1 is a diagram which shows a usage environment and the like of an information processing system 1 and a management server 300. The information processing system 1 includes a first device (a mobile object device) 100 mounted on a mobile object M, and a second device (a user device) 200 used by a user U at a location different from the mobile object M (a location that happens to be close to the mobile object M is not excluded). Each of the first device 100, the second device 200, and the management server 300 communicates with the others via a network NW. The information processing system 1 may or may not include the management server 300.

The management server 300 includes, for example, a communication device 310, a matching processing unit 320, and a storage unit 350. User data 360 is stored in the storage unit 350.

The communication device 310 is a communication interface for connecting to the network NW. Communication between the communication device 310 and the first device 100 and communication between the communication device 310 and the second device 200 are performed according to, for example, transmission control protocol/Internet protocol (TCP/IP).

The matching processing unit 320 is realized by, for example, a processor such as a central processing unit (CPU) executing a program (a command group) stored in a storage medium. The storage unit 350 is a random access memory (RAM), a hard disk drive (HDD), a flash memory, or the like.

FIG. 2 is a diagram which shows an example of content of the user data 360. The user data 360 includes, for example, an occupant list 360A in which an occupant ID that is identification information of an occupant P, communication identification information (an IP address, and the like) thereof, and a user ID that is identification information of a user U to be matched are associated with each other, and a user list 360B in which a user ID, communication identification information (an IP address, and the like) thereof, and an occupant P to be matched are associated with each other. The user data 360 may be generated in any manner other than the mode shown in FIG. 2 as long as it includes these types of information.

When the communication device 310 receives a matching request from the user U via the second device 200 or from the occupant P via the first device 100, the matching processing unit 320 refers to the user data 360 to perform matching of the matching user U and the occupant P, and transmits communication identification information of the first device 100 of the occupant P to the second device 200 of the user U that has been matched, and communication identification information of the second device 200 of the user U to the first device 100 of the occupant P that has been matched using the communication device 310. Between the first device 100 and the second device 200 that have received this information, communication with higher real-time characteristics is performed in accordance with, for example, user datagram protocol (UDP).

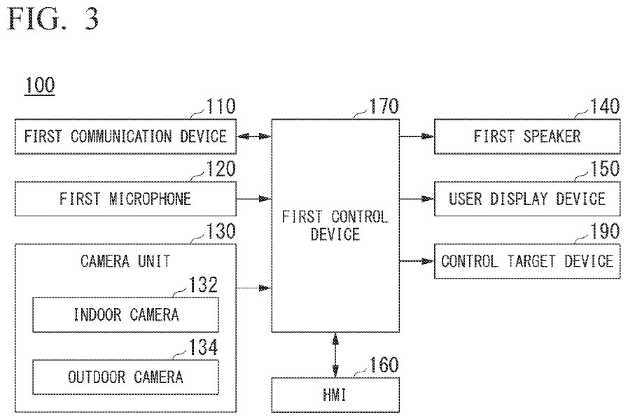

FIG. 3 is a configuration diagram of the first device 100. The first device 100 includes, for example, a first communication device 110, a first microphone 120, a camera unit 130, a first speaker 140, a user display device 150, a human machine interface (HMI) 160, and a first control device 170. The first control device 170 is connected to the control target device 190 mounted on the mobile object M.

The first communication device 110 is a communication interface for communicating with each of the communication device 310 of the management server 300 and the second communication device 210 of the second device 200 via the network NW.

The first microphone 120 collects at least a voice uttered by the occupation P. The first microphone 120 may be provided inside the mobile object M and have a sensitivity capable of collecting the voice outside the mobile object M, or may also include a microphone provided inside the mobile object M and a microphone provided outside the mobile object M. The collected voice of the first microphone 120 is transmitted to the second communication device 210 by the first communication device 110 via, for example, the first control device 170.

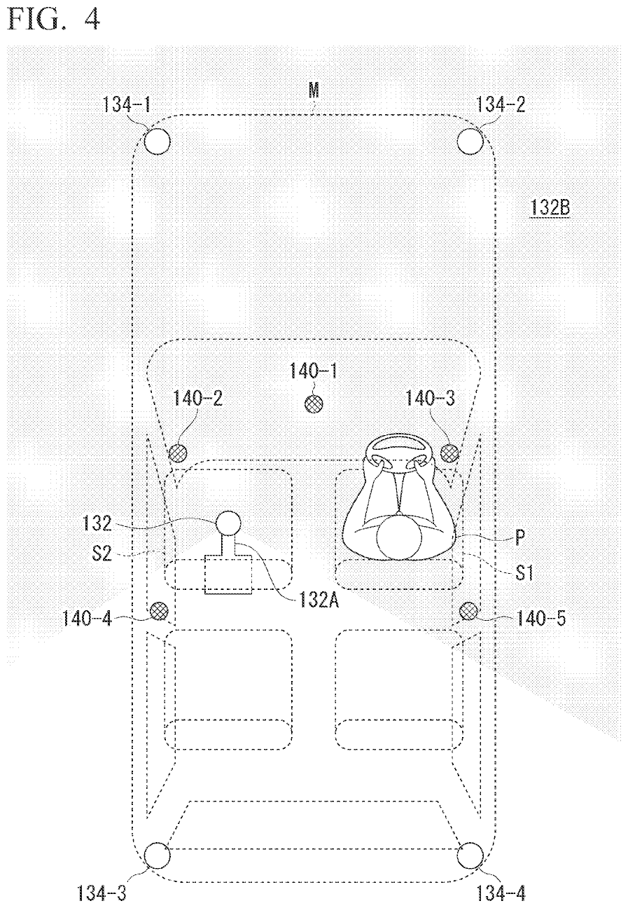

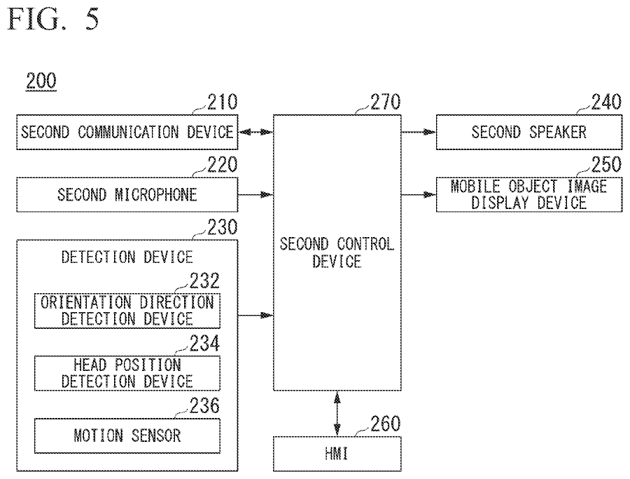

The camera unit 130 includes at least an indoor camera 132 and may include an outdoor camera 134. The first speaker 140 outputs the voice uttered by the user U, which is acquired via the first communication device 110. Details such as an arrangement of the camera unit 130 and the first speaker 140 will be described below with reference to FIG. 4.

The user display device 150 virtually displays the user U as if the user U is present inside the mobile object M. For example, the user display device 150 causes a hologram to appear, or displays the user U in a portion corresponding to a mirror or window of the mobile object M.

The HMI 160 is a touch panel, voice answering device (an agent device), or the like. The HMI 160 receives various instructions of the occupant P with respect to the first device 100.

The first control device 170 includes, for example, a processor such as a CPU, and a storage medium that is connected to the processor and stores a program (command group), and the processor executes a command group, thereby controlling each unit of the first device 100.

The control target device 190 is, for example, a navigation device mounted on the mobile object M, a driving assistance device, or the like.

FIG. 4 is a diagram which shows an arrangement example of part of the first device 100 in the mobile object M. The indoor camera 132 is attached to, for example, a neck pillow of the assistant driver's seat S2 (an example of the “predetermined seat”) via an attachment 132A, and is provided at a position slightly separated from a backrest of the assistant driver's seat S2 in a traveling direction of the mobile object M. The indoor camera 132 has a wide-angle lens and is capable of capturing an image of a range represented by a hatched area 132B in FIG. 4. The indoor camera 132 can photograph not only an inside of the mobile object M but also an outside thereof through a window. In the following description, it is assumed that the assistant driver's seat S2 is the predetermined seat, but the predetermined seat may be another seat such as a rear seat.

The outdoor camera 134 includes, for example, a plurality of child outdoor cameras 134-1 to 134-4. By synthesizing images captured by the plurality of child outdoor cameras 134-1 to 134-4, an image such as a panoramic image obtained by capturing the outside of the mobile object M can be obtained. The outdoor camera 134 may include a wide-angle camera provided on a roof of the mobile object M instead of (or in addition to) these cameras. As the indoor camera 132, a camera capable of capturing an image of a rear of the assistant driver's seat S2 may be added, a mobile object image, which will be described below, may be combined with images captured by one or more indoor cameras 132 by the first control device 170 to be generated as a 360-degree panoramic image, or an image captured by the indoor camera 132 and an image captured by the outdoor camera 134 may be appropriately combined to be generated as the 360-degree panoramic image.

The first speaker 140 outputs a voice of the user U obtained via the first communication device 110. The first speaker 140 includes, for example, a plurality of first child speakers 140-1 to 140-5. For example, a first child speaker 140-1 is arranged at a center of an instrument panel, a first child speaker 140-2 is arranged at a left end of the instrument panel, a first child speaker 140-3 is arranged at a right end of the instrument panel, a first child speaker 140-4 is arranged at a bottom of a left door, and a first child speaker 140-5 is arranged at a bottom of a right door, respectively. When the first control device 170 causes the first speaker 140 to output the voice of the user U, it causes, for example, the first child speaker 140-2 and the first child speaker 140-4 to output the voice at the same volume, and localizes a sound image so that the voice from the assistant driver's seat S2 is audible to the occupant P seated in the driver's seat S1 by turning off the other first child speakers. In addition, a sound image localization method is not limited to adjusting a volume, but may be performed by shifting a phase of a sound output by each first child speaker. For example, when the sound image is localized so that a sound is audible from a left side, a timing for outputting the sound from a first child speaker on the left side needs to be slightly earlier than a timing for outputting the same sound from a first child speaker on a right side.

In addition, when the first control device 170 causes the first speaker 140 to output the voice of user U, it may localize a sound image so that the voice is audible from a height position corresponding to a height of a head of the user U on the assistant driver's seat S2 to the occupant P, and cause the first speaker 140 to output the voice uttered by the user U. In this case, the first speaker 140 needs to have the plurality of first child speakers 140-k (k is a plurality of natural numbers) with different heights.

FIG. 5 is a configuration diagram of the second device 200. The second device 200 includes, for example, a second communication device 210, a second microphone 220, a detection device 230, a second speaker 240, a mobile object image display device 250, an HMI 260, and a second control device 270. The detection device 230 includes, for example, an orientation direction detection device 232, a head position detection device 234, and a motion sensor 236.

The second communication device 210 is a communication interface for communicating with each of the communication device 310 of the management server 300 and the first communication device 110 of the first device 100 via the network NW.

The second microphone 220 collects the voice uttered by the user U. The collected voice of the second microphone 220 is transmitted to the first communication device 110 via, for example, the second control device 270 by the second communication device 210.

The orientation direction detection device 232 is a device for detecting an orientation direction. An orientation direction is an orientation based on a face orientation or a line of sight orientation of the user U or both of these. Alternatively, an orientation direction may be a direction indicated by a motion of the arm or fingers, such as a motion of tilting a terminal device used by the user U or a motion of swiping the screen. In the following description, it is assumed that an orientation direction is an angle in a horizontal plane, that is, an angle that does not have a vertical component, but the orientation direction may be an angle that also includes a vertical component. The orientation direction detection device 232 may include a physical sensor (for example, an acceleration sensor, a gyro sensor, or the like) attached to VR goggles, which will be described below, an infrared sensor for detecting a plurality of positions of the head of the user U, or a camera capturing an image of the head of the user U. In any of the cases, the second control device 270 calculates the orientation direction on the basis of information input from the orientation direction detection device 232. Since various technologies for this are known, detailed description thereof will be omitted.

The head position detection device 234 is a device for detecting a position (height) of the head of the user U. For example, one or more infrared sensors or optical sensors installed around a chair on which the user U sits may be used as the head position detection device 234. In this case, the second control device 270 detects the position of the head of the user U on the basis of a presence or absence of a detection signal from one or more infrared sensors or optical sensors. Alternatively, the head position detection device 234 may be an acceleration sensor attached to the VR goggles. In this case, the second control device 270 detects the position of the head of the user U by integrating results of subtracting a gravitational acceleration from an output of the acceleration sensor. Information on the position of the head obtained in this manner is provided to the second control device 270 as height information. The position of the head of the user may be obtained on the basis of an operation of the user U with respect to the HMI 260. For example, the user U may enter his or her height numerically into the HMI 260 or may use a dial switch included in the HMI 260 to enter his or her height. In these cases, the position of the head, that is, height information, is calculated from the height. In addition, the user U may input discrete values such as physique: large, medium, or small to the HMI 260 instead of continuous values. In this case, height information is acquired on the basis of information indicating the physique. Moreover, a height of the head of the user U may be simply obtained on the basis of a general adult physique (which may be depending on a gender) instead of specially obtaining the height of the head of the user.

The motion sensor 236 is a device for recognizing a gesture operation performed by the user U. For example, a camera that captures an image of the upper body of the user U is used as the motion sensor 236. In this case, the second control device extracts feature points of the body of the user U (fingertips, wrists, elbows, or the like) from the image captured by the camera, and recognizes a gesture operation of the user U on the basis of motions of the feature points.

The second speaker 240 outputs the voice uttered by the occupant P acquired via the second communication device 210. The second speaker 240 has, for example, a function of changing a direction in which voice is heard. The second control device 270 causes the second speaker to output the voice so that the user U can hear the voice from a position of the occupant P as viewed from the assistant driver's seat S2. The second speaker 240 includes a plurality of second child speakers 240-n (n is a plurality of natural numbers), and the second control device 270 may perform sound image localization by adjusting a volume of each of the second child speakers 240-n, and may also perform sound image localization using a function of the headphones when headphones are attached to the VR goggles.

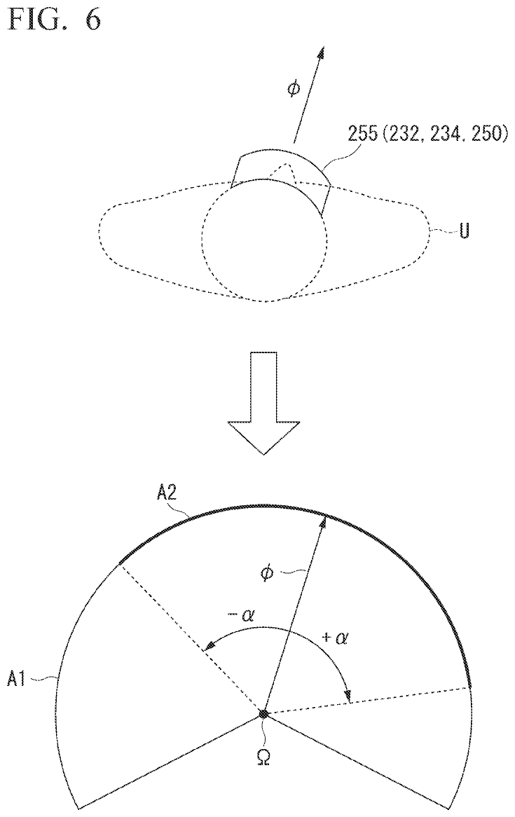

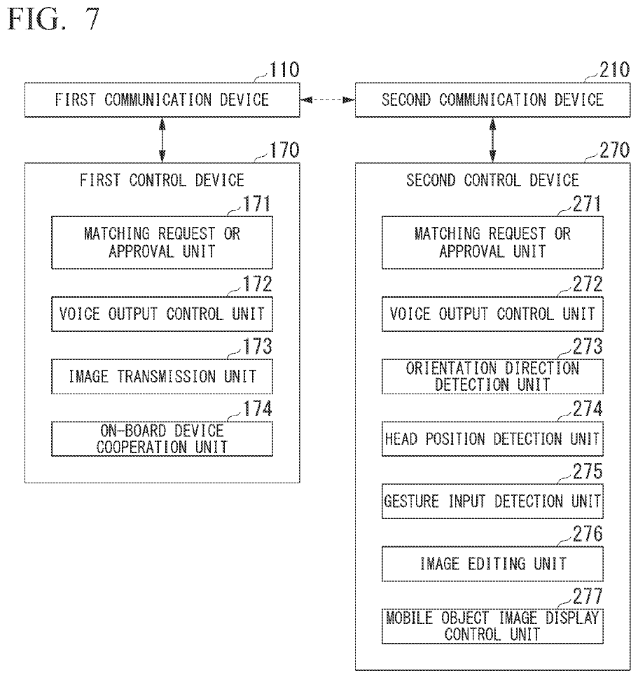

The mobile object image display device 250 displays an image which corresponds to the orientation direction as viewed from the assistant driver's seat among images captured by the camera unit 130 (which may be images that have undergone combining processing described above, and is hereinafter referred to as mobile object images). FIG. 6 is a diagram for describing an image corresponding to the orientation direction. In the example of FIG. 6, VR goggles 255 include the orientation direction detection device 232, a physical sensor as the head position detection device 234, and the mobile object image display device 250. The second control device 270 detects a direction of the VR goggles 255 as an orientation direction φ using a previously calibrated direction as a reference direction. Since various technologies for such functions are already known, detailed description thereof will be omitted.

The mobile object image display device 250 displays an image A2 in an angular range of plus or minus a centered on the orientation direction φ toward the user U among the mobile object image A1 (which has an angle of about 240 degrees in FIG. 6, but an angle of view may be expanded by the combining processing as described above).

The HMI 260 is a touch panel, a voice answering device (an agent device), the switch or the like described above. The HMI 260 receives various instructions from the occupant P with respect to the second device 200.

The second control device 270 includes, for example, a processor such as a CPU, and a storage medium that is connected to the processor and stores a program (a command group), and controls each part of the second device 200 by a processor executing a command group.

<Functional Configuration>

Hereinafter, a functional configuration of the first control device 170 and the second control device 270 will be described.

### First Example

FIG. 7 is a diagram which shows a first example of the functional configuration of the first control device 170 and the second control device 270. In the first example, the first control device 170 includes a matching request or approval unit 171, a voice output control unit 172, an image transmission unit 173, and an on-board device cooperation unit 174. The second control device 270 includes a matching request or approval unit 271, a voice output control unit 272, an orientation direction detection unit 273, a head position detection unit 274, a gesture input detection unit 275, an image editing unit 276, and a mobile object image display control unit 277. These functional units are realized by a processor such as a CPU executing a program (a command group). Some or all of these components may be realized by hardware (circuit unit; including circuitry) such as large scale integration (LSI), an application specific integrated circuit (ASIC), a field-programmable gate array (FPGA), and a graphics processing unit (GPU), or may also be realized by software and hardware in cooperation.

The matching request or approval unit 171 uses the HMI 160 to receive an input of a matching request from the occupation P and transmit it to the management server 300 or uses the HMI 160 to receive an input of an approval for the matching request received from the management server 300 and transmit it to the management server 300. The matching request or approval unit 171 controls the first communication device 110 so that the second device 200 of the user U whose matching has been established is set to a communication partner.

The voice output control unit 172 controls the first speaker 140 as described above.

The image transmission unit 173 uses the first communication device 110 to transmit the mobile object image A1 to the second device 200.

The on-board device cooperation unit 174 controls the control target device 190 on the basis of the instruction signal input from the second device 200.

The matching request or approval unit 271 uses the HMI 260 to receive an input of a matching request from the user U, and transmit it to the management server 300, or receives an input of an approval for the matching request received from the management server 300 using the HMI 260, and transmit it to the management server 300. The matching request or approval unit 271 controls the second communication device 210 so that the first device 100 of the occupation P for which matching has been established is a communication partner.

The voice output control unit 272 controls the second speaker 240 as described above.

The orientation direction detection unit 273 detects the orientation direction φ on the basis of an output of the orientation direction detection device 232. The head position detection unit 274 detects the height of the head of the user U on the basis of an output of the head position detection device 234. The head position may be expressed as three-dimensional coordinates, or the height of the head may be simply detected as the head position. The gesture input detection unit 275 detects a gesture input of the user U on the basis of an output of the motion sensor 236.

The image editing unit 276 performs processing of cutting out an image A2 corresponding to the orientation direction φ viewed from the assistant driver's seat from the mobile object image A1 (FIG. 6). The mobile object image display control unit 277 causes the mobile object image display device 250 to display the image A2 cut out by the image editing unit 276. At this time, the image editing unit 276 may cause the mobile object image display device 250 to display an image corresponding to the orientation direction φ viewed from a height indicated by height information of the head of the user U.

### Second Example

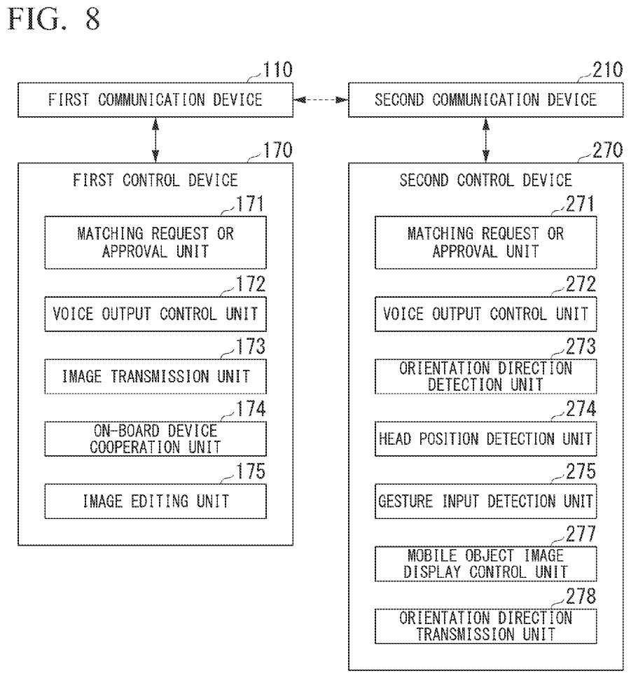

FIG. 8 is a diagram which shows a second example of the functional configuration of the first control device 170 and the second control device 270. As compared to the first example of FIG. 7, the second example is different in that the first control device 170 includes an image editing unit 175 and the second control device 270 includes an orientation direction transmission unit 278 instead of the image editing unit 276. Since the other components basically have the same functions as those of the first example, the description thereof will be omitted.

The orientation direction transmission unit 278 transmits the orientation direction φ detected by the orientation direction detection unit 273 to the first device 100 using the second communication device 210.

The image editing unit 175 performs the processing of cutting out the image A2 corresponding to the orientation direction φ (transmitted from the second device 200) viewed from the assistant driver's seat from the mobile object image A1 (FIG. 6). At this time, the image editing unit 175 may acquire the height information of the head of the user U from the second device 200, and perform the processing of cutting out the image A2 corresponding to the orientation direction φ viewed from the height indicated by the height information.

The image transmission unit 173 in the second example uses the first communication device 110 to transmit the image A2 cut out by the image editing unit 175 to the second device 200. Then, the mobile object image display control unit 277 causes the mobile object image display device 250 to display the image A2 transmitted from the first device 100.

<Other>

In the information processing system 1, it was explained that the user U can visually recognize any direction viewed from the assistant driver's seat S2, but there may be a restriction provided in a direction that can be visually recognized by the user U according to, for example, an agreement at the time of matching. For example, the occupant P may provide a scenery in the traveling direction of the mobile object M or a scenery on an opposite side of the driver's seat S1, but may request that he or she does not want to display his or her own image. This is a case assumed to meet needs that the occupant P and the user U want to confirm a drive feeling of the mobile object M or want to visually recognize a desired streetscape, who are not in a relationship such as family members or friends. In this case, such a limit is set when the matching processing unit 320 of the management server 300 performs matching processing, and the first control device 170 or the second control device 270 masks the angular range that is not visually recognized or performs correction so that the orientation direction φ is not oriented in a restricted direction according to the settings. In addition, since information regarding such restrictions relates to privacy of the occupant P, it may be set on the first device 100 side.

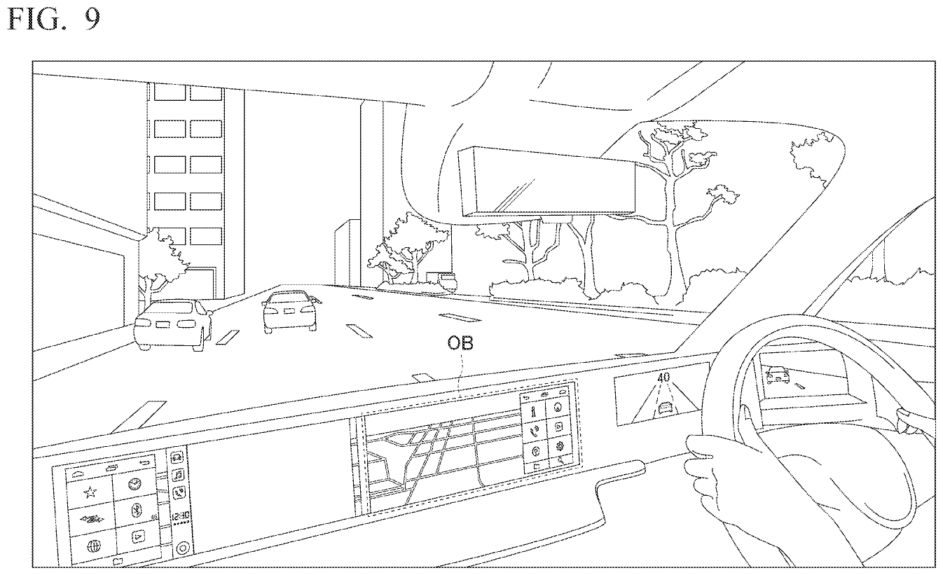

In addition, the mobile object image display device 250 may replace a portion of the images captured by the camera unit 130 in which a predetermined article inside the mobile object M is captured with an image (a CG image) drawn by computer processing and display it. FIG. 9 is a diagram which shows an example of displaying a replaced image. In FIG. 9, OB is a display device that performs navigation display, and the like, and is an example of the “predetermined article.” When an image of a display screen of a display device is displayed as it is, the image may be blurred or the visibility may be reduced due to reflection of light. For this reason, the mobile object image display device 250 may acquire data for configuring the display screen of the display device or image data drawn by computer processing in the mobile object M from the first device, and embed an image redrawn by computer processing from the data or the acquired image data in the image (an edited image) captured by the camera unit 130 to display it. In this case, a position of an article inside the mobile object M, which is the predetermined article, is shared in advance between the first device 100 and the second device, and the mobile object image display control unit 277 determines whether the predetermined article is included in an image to be displayed on the mobile object image display device 250 on the basis of, for example, the orientation direction φ, and perform replacement of images as described above when it is determined to be included. In addition, the “predetermined article” may be the head or face of the occupant P. In that case, the CG image such as an avatar may be changed according to a display of the occupant P.

<Summary>

According to the information processing system 1 configured as described above, it is possible to enhance the sense of presence given to both the occupant P of the mobile object M and the user U who is in a different location from the mobile object M. Since an image corresponding to the orientation direction φ of the user U as viewed from the assistant driver's seat is displayed, the user U can visually recognize a scenery as if he or she were sitting on the assistant driver's seat S2 and looking around. In addition, the first speaker 140 localizes a sound image so that a voice from the assistant driver's seat S2 is audible to the occupant P, and the occupant P can perform conversation with the user U as if the user U were in the assistant driver's seat S2 by outputting the voice uttered by the user U. Furthermore, the second speaker 240 localizes a sound image so that a voice from the position of the occupant P as viewed from the assistant driver's seat S2 is audible to the user U, and the user U can have a conversation with the occupant P as if he or she were in the assistant driver's seat S2 by outputting the voice uttered by the occupant P.

### Usage Example

The information processing system 1 can be used in the following modes.

(A) A mode in which the occupant P and the user U are in a relationship of family members, friends, or the like, and a virtual drive is provided to the user U. The user U can have a conversation with the occupant P regarding a scenery around the mobile object M while looking at an image.

(B) A mode in which the occupant P is a general user and the user U is a provider of a route guidance service, a driving guidance service, and the like. The user U can give a route guidance at a location that is difficult to understand with the navigation device or that is not on the map while looking at the surrounding scenery of the mobile object M, and can give a guidance on driving operations.

(C) A mode in which the occupant P is a celebrity, the user U is a general user, and user U is provided with a commercial-based virtual drive. In this case, a plurality of users U are associated with one occupant P at the same time, and, for example, a transfer of a voice from the user U side may be turned off.

As described above, a mode for implementing the present invention has been described using the embodiments, but the present invention is not limited to such embodiments at all, and various modifications and replacements can be added within a range not departing from the gist of the present invention.

What is claimed is:

1. An information processing system comprising:
a first device that is mounted on a mobile object boarded by an occupant; and
a second device that is used by a user at a location different from the mobile object,
wherein the first device includes:
a first communication device configured to communicate with a second communication device of the second device;
a first speaker configured to output a voice uttered by the user, which is acquired via the first communication device; and
a camera unit that is provided on a predetermined seat of the mobile object and has one or more cameras including at least an indoor camera capable of capturing an image of an interior of the mobile object viewed from the predetermined seat, and
wherein the second device includes:
the second communication device configured to communicate with the first communication device;
a second microphone configured to collect a voice uttered by the user;
a detection device for detecting an orientation direction of the user; and
a display device configured to display an image corresponding to the orientation direction viewed from the predetermined seat among images captured by the camera unit, and
wherein the second communication device transmits a voice collected by the second microphone to the first communication device.

2. The information processing system according to claim 1,
wherein the first speaker causes the occupant to localize a sound image so that the voice is audible from the predetermined seat and outputs the voice uttered by the user.

3. The information processing system according to claim 2,
wherein the first speaker includes a plurality of first child speakers arranged at positions different from each other, and
the first device further includes a first control device that causes the occupant to localize a sound image so that the voice is audible from the predetermined seat by adjusting a volume and/or a phase difference of the plurality of first child speakers.

4. The information processing system according to claim 3,
wherein the second device further acquires height information indicating a height of the head of the user, and
the first control device causes the occupant to localize a sound image so that the voice is audible from a height position represented by the height information on the predetermined seat, and causes the first speaker to output the voice uttered by the first speaker.

5. The information processing system according to claim 1,
wherein the second device further acquires height information indicating a height of the head of the user, and
the display device displays an image corresponding to the orientation direction viewed from the height indicated by the height information on the predetermined seat.

6. The information processing system according to claim 1,
wherein the second communication device transmits information on the orientation direction to the first communication device,
the first device further has a first control device for controlling the first communication device to selectively transmit the image corresponding to the orientation direction acquired via the first communication device among the images captured by the camera unit to the second communication device, and
a display device of the second device displays the image corresponding to the orientation direction viewed from the predetermined seat, which is acquired via the second communication device.

7. The information processing system according to claim 1,
wherein the first communication device transmits the images captured by the camera unit to the second communication device, and
the second device further has a second control device that causes the display device to selectively display the image corresponding to the orientation direction among the images captured by the camera unit.

8. The information processing system according to claim 1,
wherein the first device further has at least a first microphone that collects a voice uttered by the occupant, and the second device further has a second speaker that outputs the voice uttered by the occupant and acquired via the second communication device, and
the first communication device transmits a voice collected by the first microphone to the second communication device.

9. The information processing system according to claim 8,
wherein the second speaker causes the user to localize a sound image so that a voice is audible from a position of the occupant viewed from the predetermined seat, and outputs the voice uttered by the occupant.

10. The information processing system according to claim 1,
wherein the display device is a display device of virtual reality (VR) goggles, and
the detection device includes a physical sensor attached to the VR goggles.

11. The information processing system according to claim 1,
wherein the display device is capable of executing a mode in which a displayable angular range of the display device is limited.

12. The information processing system according to claim 1,
wherein the mobile object is a vehicle, and
the predetermined seat is an assistant driver's seat.

13. The information processing system according to claim 1,
wherein the display device replaces a portion of the images captured by the camera in which a predetermined article inside the mobile object is captured with an image drawn by computer processing and displays the image.
